(19) United States
(12) Patent Application Publication
(10) Pub. No.: US 2012/0151126 A1
(43) Pub. Date: Jun. 14, 2012

(54) FLASH DRIVE WITH MULTIPLE CONNECTORS

(75) Inventor: Lana Beth Moore, Richardson, TX (US)

(73) Assignee: TEXAS INSTRUMENTS INCORPORATED, Dallas, TX (US)

(21) Appl. No.: 13/314,409

(22) Filed: Dec. 8, 2011

Related U.S. Application Data
(60) Provisional application No. 61/422,019, filed on Dec. 10, 2010.

(51) Int. Cl. G06F 12/00; G06F 1/16

(52) U.S. Cl. 711/103; 361/679.32; 711/E12.008

(57) ABSTRACT

A data storage stick is described that has a nonvolatile memory circuit disposed within a protective cover. Interface circuitry is coupled to the nonvolatile memory circuit and is configured to provide data access to the nonvolatile memory circuit. A first interface connector is coupled to the interface circuitry, penetrates the protective cover, and conforms to a first physical format. A second interface connector is coupled to the interface circuitry, penetrates the protective cover, and conforms to a second physical format.

### CLAIM OF PRIORITY UNDER 35 U.S.C. 119(e)

The present application claims priority to and incorporates by reference U.S. Provisional Application No. 61/422,019, (attorney docket TI-70225PS) filed Dec. 10, 2010, entitled “A Method and an Apparatus for a Mini USB.”

### FIELD OF THE INVENTION

This invention generally relates to a USB flash drive with multiple connectors, such as a standard USB connector and a mini USB connector.

### BACKGROUND OF THE INVENTION

A USB flash drive is a data storage device that consists of flash memory with an integrated Universal Serial Bus (USB) interface. USB flash drives are typically removable and rewritable. Most weigh less than 30 g (1 oz). As of September 2011 drives of 256 gigabytes (GB) are available, and storage capacities as large as 2 terabytes (TB) are planned, with steady improvements in size and price per capacity expected. Some allow up to 100,000 write/erase cycles (depending on the exact type of memory chip used) and 10 years shelf storage time.

USB flash drives are often used for the same purposes for which floppy disks or CD-ROMs were used. They are smaller, faster, have thousands of times more capacity, and are more durable and reliable because they have no moving parts. Until approximately 2005, most desktop and laptop computers were supplied with floppy disk drives, but floppy disk drives have been abandoned in favor of USB ports.

USB Flash drives use the USB mass storage standard, supported natively by modern operating systems such as Linux, Mac OS X, Windows, and other Unix-like systems. USB drives with USB 2.0 support can store more data and transfer faster than much larger optical disc drives like CD-RW or DVD-RW drives and can be read by many other systems such as the Xbox 360, PlayStation 3, DVD players and some upcoming mobile smartphones.

Nothing moves mechanically in a flash drive; the term drive persists because computers read and write flash-drive data using the same system commands as for a mechanical disk drive, with the storage appearing to the computer operating system and user interface as just another drive. Flash drives are very robust mechanically.

A flash drive consists of a small printed circuit board carrying the circuit elements and a USB connector, insulated electrically and protected inside a plastic, metal, or rubberized case which can be carried in a pocket or on a key chain, for example. The USB connector may be protected by a removable cap or by retracting into the body of the drive, although it is not likely to be damaged if unprotected. Most flash drives use a standard type-A USB connection allowing plugging into a port on a personal computer, but drives for other interfaces also exist. USB flash drives draw power from the computer via the external USB connection.

The general operation of USB flash drives are well known and well documented, for example, “USB Flash Drive”, Wikipedia.

### SUMMARY

A data storage stick that has a nonvolatile memory circuit is disposed within a protective cover. Interface circuitry is coupled to the nonvolatile memory circuit and is configured to provide data access to the nonvolatile memory circuit. A first interface connector is coupled to the interface circuitry, penetrates the protective cover, and conforms to a first physical format. A second interface connector is coupled to the interface circuitry, penetrates the protective cover, and conforms to a second physical format.

### BRIEF DESCRIPTION OF THE DRAWINGS

Particular embodiments in accordance with the invention will now be described, by way of example only, and with reference to the accompanying drawings:

FIG. 1 is an illustration of a flash drive with two different interface connectors;

FIG. 2 is a block diagram of the flash drive of FIG. 1 with two different interface connectors;

FIG. 3 is a block diagram of an example computer system coupled to the flash drive of FIG. 1;

FIG. 4 is an illustration of a handheld calculator coupled to the flash drive of FIG. 1;

FIG. 5 is a block diagram of hardware components of the handheld calculator of FIG. 4;

FIG. 6 is a block diagram of a software system executable on the calculator of FIG. 4; and

FIG. 7 is a flow chart illustrating use of the flash drive of FIG. 1.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

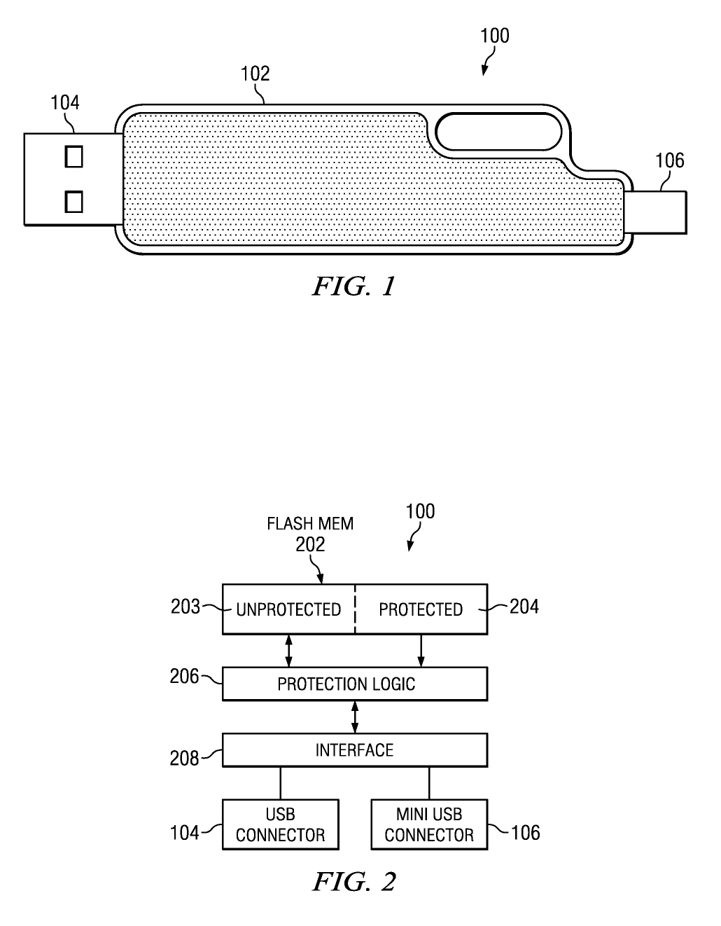

FIG. 1 is an illustration of a flash drive 100 with two different interface connectors. Protective cover 102 covers and protects a flash memory and related circuitry that provides data storage within flash drive 100. In this example, connector 104 conforms to the well known physical format for a standard type-A universal serial bus (USB) connector, while connector 106 conforms to the well known physical format for a mini USB connector. One or more standard size USB connectors are typically provided as interface connectors on digital computer systems such as personal computers, laptop computers, etc. Mini USB connectors are typically proved as interface connectors on handheld mobile devices such as cameras, cell phones, calculators, etc.

Flash drive 100 may be connected to a computer device using USB connector 104 and have data transferred to and from the flash drive under control of the computer system's operating system. Flash drive 100 may also be connected to a handheld mobile device using mini USB connector 106 and have data transferred to and from the handheld mobile device under control of software on the mobile device. In this manner, data may be uploaded from a mobile device to flash drive 100 via mini USB connector 106, and then downloaded from flash drive 100 to a digital computer system via USB connector 104, or visa versa.

FIG. 2 is a block diagram of flash drive 100 of FIG. 1 that has two different interface connectors 104, 106. Nonvolatile memory 202 may be a single memory device or a combination of several devices mounted on a substrate that is contained within protective cover 102. In this embodiment, memory 202 is a flash memory having a storage capacity of 64 gigabytes; however, other embodiments may provide a smaller or a larger capacity memory. In this embodiment, nonvolatile memory 202 is a flash memory; however, other embodiments may use other types of nonvolatile memory now known or later developed. Flash memory is a non-volatile storage device that can be electrically erased and reprogrammed. It was developed from EEPROM (electrically erasable programmable read-only memory) and may be erased in fairly large blocks and be rewritten with new data. The high density NAND type may also be programmed and read in blocks, or pages, while the NOR type allows a single machine word (byte) to be written and/or read independently.

In this embodiment, protection logic 206 is configured to partition memory 202 into a protected region 204 and an unprotected region 203. Protection logic 206 prohibits data writes to protected region 204, but allows data writes to be performed in unprotected region 203. Protection logic 206 may be initialized during manufacture of flash drive 100 to define a size for protected region 203. This may be done by a set of fuses in some embodiments. In another embodiment, configuration of protection logic 206 may be done using an EEPROM circuit, for example. In another embodiment, there may be a password value that allows configuration of protection logic 206. Other known or later developed programming techniques may be used to configure protection logic 206.

Interface logic 208 receives data access requests from both connectors 104 and 106. In this embodiment, flash drive 100 simulates a disc drive and data requests are in the form of commands to write to or read data from a disc. As such, each data request defines a track and sector location. Interface logic 208 converts the requested track and sector location into sequential addresses in nonvolatile memory 202. Data write requests are received and the accompanying data is stored in unprotected region 203 when that is the specified destination. When the write request specifies a region within protected region 204, then the write request is blocked by protection logic 206 based on the requested address. Read requests are allowed to access both the protected and unprotected regions.

Application programs or other data such as advertising or promotional information may be installed within protected region 206. The installation of these programs and data may be performed prior to configuring the protection logic in an embodiment in which the configuration of the protection logic is irreversible. For embodiments in which the configuration of the protection logic may be changed, such as by EEPROM action or password, a supervisory function may temporarily reconfigure the protection logic to allow an application program or other data to be installed in protected region 204.

While a standard USB connector 104 and a mini USB connector 106 have been described herein, other embodiments may use other combinations of connectors that conform to other physical formats. For example, one connector may conform to an IEEE 1394 format, also known as Apple's “Firewire”, Sony's “i.LINK”, or Texas Instrument's “Lynx”. In another embodiment, one connector may conform to a micro USB physical format. For embodiments in which another physical format is used, interface logic 208 is designed to support the electrical format of the chosen physical format.

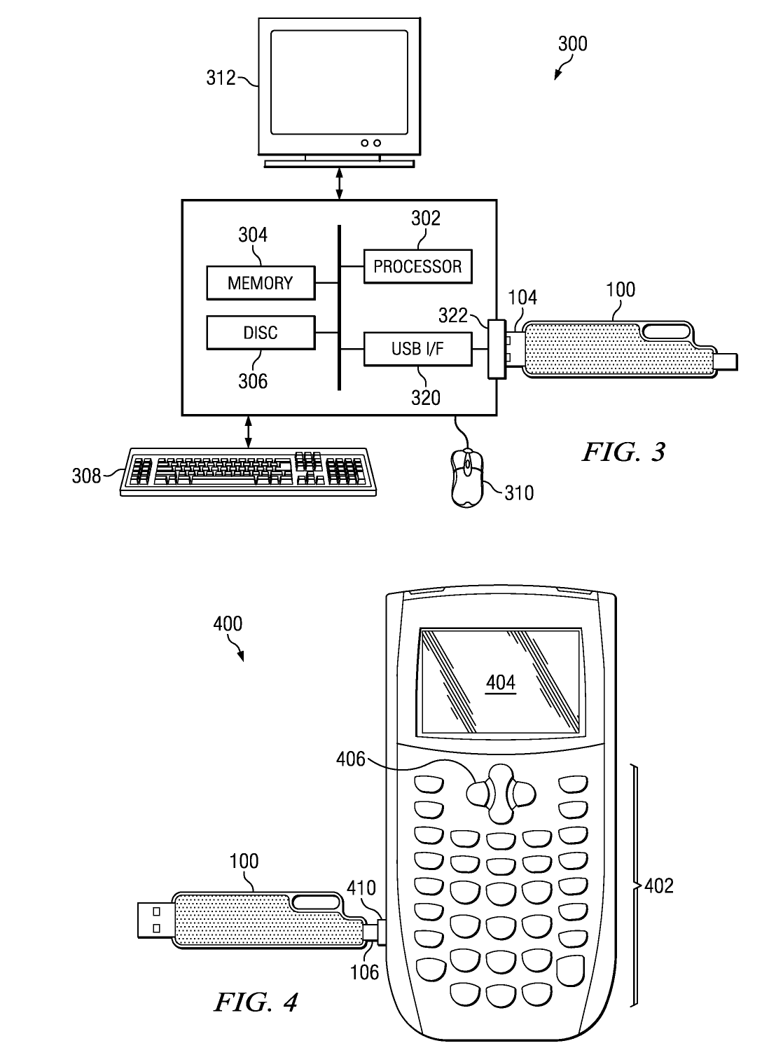

FIG. 3 is a block diagram of a digital computer device 300, such as a personal computer, portable computer, tablet computer, etc., coupled to USB flash drive 100 via standard USB connector 104. Computer device 300 includes a processor 302, associated memory 304, a disc storage device 306, and numerous other elements and functionalities typical of digital systems (not shown). In one or more embodiments of the invention, a digital system may include multiple processors and/or one or more of the processors may be digital signal processors. The digital system 300 may also include input means, such as a keyboard 308 and a mouse 310 (or other cursor control device), and output means, such as a monitor 312 (or other display device). Those skilled in the art will appreciate that the input and output means may take other forms.

The digital system 300 may be connected to a network (not shown) (e.g., a local area network (LAN), a wide area network (WAN) such as the Internet, a cellular network, any other similar type of network and/or any combination thereof) via a network interface connection (not shown). The digital system 300 may include functionality to receive and display encoded video sequences via the network interface connection, from the storage device 306, and/or from removable storage media.

USB interface 320 provides an interface to standard USB connector 322. Standard USB connector 104 of flash drive 100 may be mated with USB connector 322. Operating system software on computer device 300 may transfer data to and from flash drive 100 using known file access commands in response to user commands input via keyboard 308 and/or mouse 310 in conjunction with a graphical user interface provided on monitor 312.

FIG. 4 is an illustration of a handheld calculator 400 coupled to flash drive 100 via mini USB connector 106. Calculator 400 provides an interface to USB connector 410. Mini USB connector 106 of flash drive 100 may be mated with mini USB connector 410. Operating system software on calculator device 400 may transfer data to and from flash drive 100 using known file access commands in response to user commands input via keyboard 402 and/or selection keys 406 in conjunction with a graphical user interface provided on display 404.

For illustrative purposes, the handheld calculator shown in FIG. 4 is similar to graphing calculators available from Texas Instruments, Inc. As shown in FIG. 4, the handheld calculator 400 includes a graphical display 404 and a set of keys 402. The graphical display 404 may be used to display outputs of processes executing on the handheld calculator 400. The graphical display 404 may be, for example, an LCD display. The set of keys 402 allows a user to enter data and to start and interact with the processes executing on the handheld calculator 400. The selection keys 406 allow a user to move a cursor on display 404. The handheld calculator 400 may include a central processing unit (CPU), memory, a power supply, and other hardware components that provide functionality beyond the minimum calculator functions.

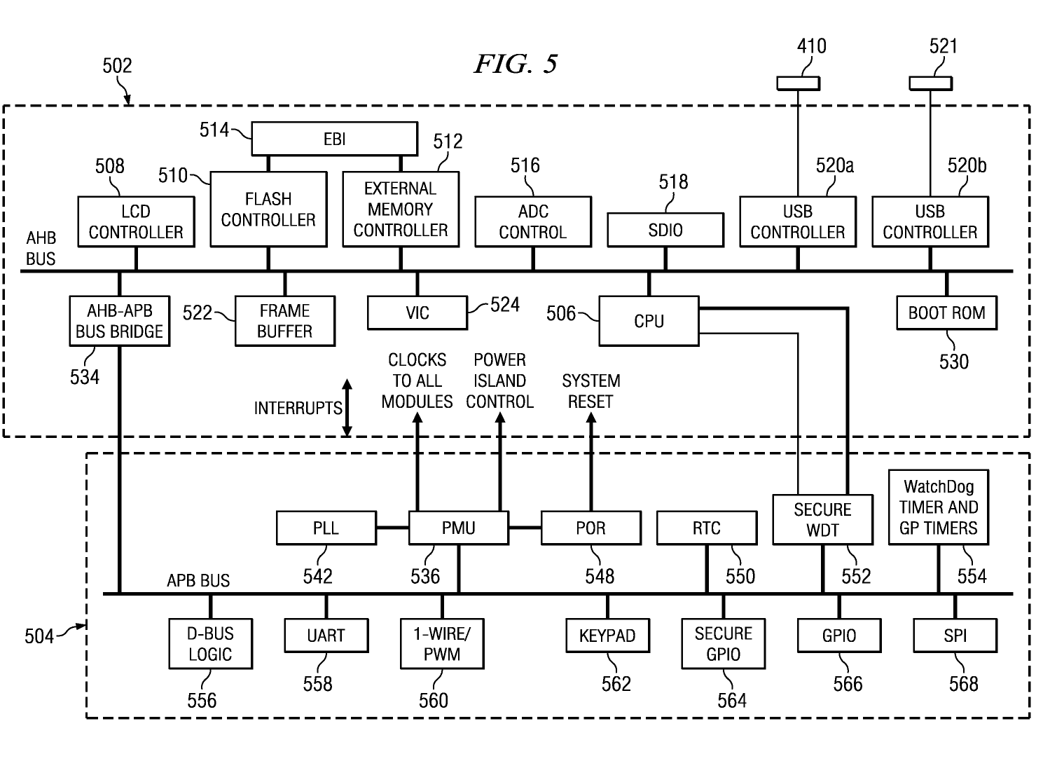

FIG. 5 is a block diagram illustrating in more detail hardware components that may be incorporated in the handheld calculator 400. In one or more embodiments, the illustrated hardware components may be packaged in an application specific integrated circuit (ASIC). Mini USB connector 410 is connected to USB controller 520a. In this embodiment, a second mini USB connector 521 is connected to USB controller 520b. Flash drive 100 may be coupled to either connector 410, 521 in order to transfer data to and from calculator device 400.

The components are organized into two power domains, i.e., power islands, a controllable power domain 502 and a non-controllable power domain 504. The controllable power domain 502 is a power domain that can have power removed from/restored to the components in the power domain while other components in the handheld calculator 400 remain powered. The controllable power domain 504 includes the following components: an LCD controller 508, a flash memory controller 510, an external memory controller 512, an external bus interface (EBI) 514 to external, i.e., off-chip, memory, an analog-to-digital converter (ADC) control 516, a secure digital input/output interface (SDIO) 518, universal serial bus (USB) controllers 520, a boot ROM 530, a frame buffer 522, a vector interrupt controller (VIC) 524, an AHB-APB bus bridge 534, and a CPU 506. These components are all connected by an AHB bus. As is well-known in the art, an AHB bus is an advanced microprocessor bus architecture (AMBA) high performance bus designed to be used on-chip.

The non-controllable power domain 504 includes the following components: a power management unit 536, a phase locked loop (PLL) component 542, a power on reset (POR) component 548, a real-time clock (RTC) 550, a secure watchdog timer 552, a non-secure timer component 554, a keypad interface component 562, and various other peripheral interfaces including serial ports 558, 568, general purpose input/output interfaces 564, 566, a battery monitoring interface 560, and an interface for connecting the calculator to a computer 556. These components are all connected by an APB bus. As is well-known in the art, an APB bus is an AMBA advanced peripheral bus designed to be used on-chip.

The general functionality of many of the components listed above will be understood by one of ordinary skill in the art and is not described herein. The frame buffer 522 is on-chip memory, e.g., static random access memory (SRAM), used as a frame buffer by the LCD controller 508. In one or more embodiments, the size of the frame buffer 522 is 78 KB. The external memory controller 512 controls accesses to external memory, e.g., synchronous dynamic random access memory (SDRAM). The external memory may be any suitable memory that can retain its contents with minimal power consumption when the external memory controller 512 is disabled. For example, SDRAM may be placed in a self-refresh mode in which a timer generates internal refresh cycles as needed to retain contents. This mode allows the memory controller to be disabled entirely and the clock may also be stopped.

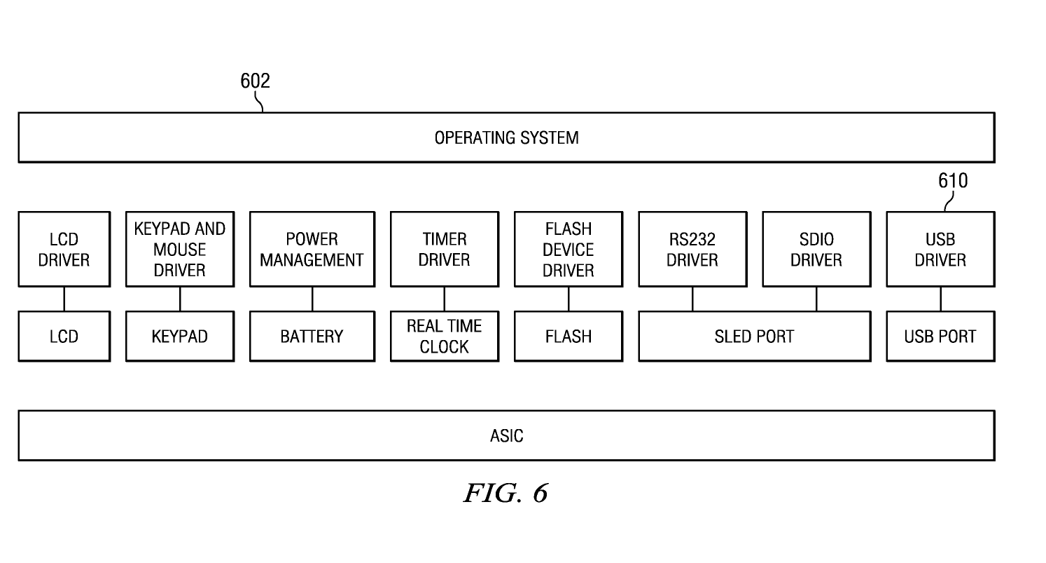

FIG. 6 is a block diagram illustrating some of the software modules of the handheld calculator 400. The general functionality of many of the software components shown in FIG. 6 will be understood by one of ordinary skill in the art and is not described herein. As shown in FIG. 6, the handheld calculator 400 includes an operating system 602, a USB driver 610, and various drivers for the other hardware components of FIG. 5. The operating system 602 may be any suitable operating system, such as, for example, the Nucleus operating system available from Mentor Graphics Corporation.

Operating system software 602 on calculator device 400 may transfer data to and from flash drive 100 when it is connected to either mini USB connector 410, 521 using known file access commands provided to USB driver 610 in response to user commands input via keyboard 402 and/or selection keys 406 in conjunction with a graphical user interface provided on monitor 404.

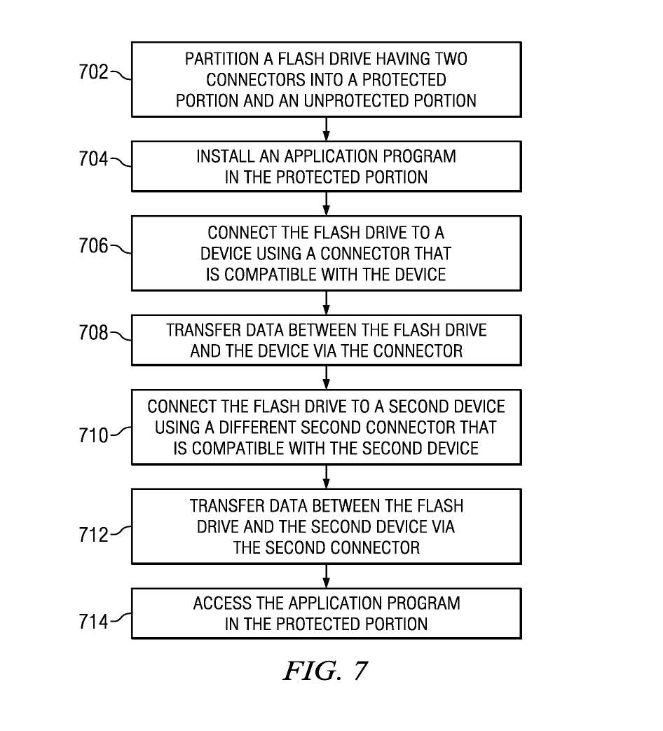

FIG. 7 is a flow chart illustrating use of flash drive 100 to transfer between two devices that have physically different interface connectors. A data storage stick having nonvolatile memory may be connected 706 to the first device using a first interface connector on the data storage stick that conforms to a first physical format. Data may then be transferred 708 between the data storage stick and the first device via the first interface connector. As described in more detail above, the first device may be a computer that provides a standard USB connector. Data may be transferred to/from the data storage stick using standard file access commands in response to user input.

The data storage stick may then be connected 710 to the second device using a second interface connector on the data storage stick that conforms to a second physical format. Data may then be transferred 712 between the data storage stick and the second device via the second interface connector. As described above, the second device may be a calculator that provides a mini USB connector. Data may be transferred to/from the data storage stick using standard file access commands in response to user input.

In some embodiments, the nonvolatile memory may be partitioned 702 into a protected read only portion and an unprotected portion. In this case, a user may read and write data to the unprotected region, but only read data from the protected region.

As described in more detail above, an application program or other data may be installed 704 in the protected region before the protected region is configured, or by a supervisory function that has permission to temporarily reconfigure the protected region. The application program and/or data may then be accessed 714 from the protected region by a user on each device when it is connected to the data storage stick. For example, the application program may present a graphical user interface (GUI) on a calculator display that prompts a user to transfer data between the data storage stick and the calculator. The data may be calculation sequences that have been created on the calculator to solve a particular math problem, for example.

For example, this allows for the creation for artifacts that can be shared between the peripheral device and the computer, specifically in this case, a TI-Nspire graphing handheld device. A user has the ability to easily upload artifacts from a handheld calculator to the computer to use for web pages, blogs, visual learning environment (VLE), content management system (CMS) and to share with others by transferring from handheld device to handheld device.

A user may view a flash presentation with robust marketing content from the protected region. The user may view RSS (really simple syndication) feeds with current marketing messaging, view RSS feeds of updated content, be presented with an option to download and install SW (software), etc.

A user may search a digital guidebook stored in the protected area as well as save content such as pre-loaded documents, images, videos, simulations, content libraries from the calculator into the unprotected area.

A user may upgrade the operating system (OS) on the calculator by obtaining the upgraded OS via a computer device connected to a network and then transferring it to the calculator using the data storage stick.

A user may use the unprotected area for personal use.

### Other Embodiments

While the invention has been described with reference to illustrative embodiments, this description is not intended to be construed in a limiting sense. Various other embodiments of the invention will be apparent to persons skilled in the art upon reference to this description. For example, various devices that provide a mini USB connector, such as a cell phone, a camera, a personal data assistant, etc., may be connected to the flash drive via the mini USB connector on the flash drive. In this manner, data may be transferred between a computer device that only provides a standard USB connector and any of several types of handheld devices that only provide a mini USB connector.

While embodiments of a data storage stick that simulate a disc have been described, another embodiment may use a different protocol; for example, the data storage stick may be treated as a standard memory and accessed using simple memory read/write commands over one or both of the connectors. In some embodiments, one connector of the data storage stick may respond to a standard memory protocol while the other connector may respond to a flash drive protocol.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A data storage stick comprising:
a nonvolatile memory circuit disposed within a protective cover;
interface circuitry coupled to the nonvolatile memory circuit and configured to provide data access to the nonvolatile memory circuit;
a first interface connector coupled to the interface circuitry, wherein the first interface connector penetrates the protective cover and conforms to a first physical format; and
a second interface connector coupled to the interface circuitry, wherein the second interface connector penetrates the protective cover and conforms to a second physical format.

2. The data storage stick of claim 1, further comprising security circuitry coupled to the nonvolatile memory, wherein the security circuitry is configured to partition the nonvolatile memory into a protected read only portion and an unprotected portion.

3. The data storage stick of claim 2, further comprising an application program stored within the protected portion of the nonvolatile memory circuit.

4. The data storage stick of claim 1, wherein the first interface connector conforms to a standard universal serial bus (USB) physical format and the second interface connector conforms to a mini USB physical format.

5. A method for transferring data from a first device to a second device, the method comprising:
connecting a data storage stick having nonvolatile memory to the first device using a first interface connector on the data storage stick that conforms to a first physical format;
transferring data between the data storage stick and the first device via the first interface connector;
connecting the data storage stick to the second device using a second interface connector on the data storage stick that conforms to a second physical format; and
transferring data between the data storage stick and the second device via the second interface connector.

6. The method of claim 5, further comprising partitioning the nonvolatile memory into a protected read only portion and an unprotected portion.

7. The method of claim 6, further comprising accessing an application program within the protected portion of the nonvolatile memory circuit.

8. The method of claim 5, wherein the first interface connector conforms to a standard universal serial bus (USB) physical format and the second interface connector conforms to a mini USB physical format.
